(19) United States
(12) Patent Application Publication
(10) Pub. No.: US 2022/0207406 A1
(43) Pub. Date: Jun. 30, 2022

(54) METHODS FOR IMPLEMENTING ERROR-DIVIBLE QUANTUM GATES

(71) Applicant: COLORADO SCHOOL OF MINES, Golden, CO (US)

(72) Inventors: Eliot KAPIT, Golden, CO (US); David SCHUSTER, Golden, CO (US)

(21) Appl. No.: 17/564,802

(22) Filed: Dec. 29, 2021

Related U.S. Application Data
(60) Provisional application No. 63/132,933, filed on Dec. 31, 2020.

(51) Int. Cl. G06N 10/70; G06N 10/20; G06N 10/40

(52) U.S. Cl. CPC G06N 10/70; G06N 10/40; G06N 10/20

(57) ABSTRACT

An exemplary method for achieving an error divisible gate in a quantum system includes selecting an intrinsic gate error rate threshold for a gate coupled between a pair of qubits, and determining a first gate time to execute a full entangling gate rotation with a first error rate less than the intrinsic gate error rate threshold. The exemplary method further includes, based on the time to execute the full entangling gate, applying, to the gate, a second gate rotation having a second gate time less than the first gate time to determine a second error rate. The exemplary method further includes selecting the second gate time as a final gate time when the second error rate is smaller than the first error rate.

### CROSS-REFERENCE TO RELATED APPLICATIONS

This application claims priority to U.S. Provisional Application No. 63/132,933, filed Dec. 31, 2020, entitled “Methods for Implementing Error-Divisible Quantum Gates,” the contents of which are incorporated herein in their entirety for all purposes.

### BACKGROUND

Much of quantum hardware development has focused optimizing toward topological error correction codes, two-dimensional grids of locally coupled qubits with a gate set consisting of a two-qubit entangling gate, and single qubit operations. However, the requirements for effective quantum error correction have been elusive and are universal, error corrected quantum algorithms are still likely many years away. Accordingly, recent focus has been on efforts to realize quantum advantage for useful problems in noisy intermediate scale quantum (NISQ) algorithms in the short term. One area where NISQ algorithms have been established is in random quantum circuit sampling, but still falls short of being able to solve a problem of real commercial or scientific value that a classical supercomputer cannot.

### BRIEF DESCRIPTION OF THE DRAWINGS

FIG. 1 is a schematic diagram of an example two-dimensional (2D) quantum system 100 in accordance with embodiments of the present disclosure.

FIG. 2 is a flow diagram of a method for achieving an error divisible gate in a quantum system in accordance with embodiments of the present disclosure.

### DETAILED DESCRIPTION

This disclosure includes examples of methods for implementing error-divisible quantum gates. Errors caused by gates (e.g., gate errors) in 2 or 3-dimensional grids of qubits may lead to poor performance. The described error-divisible quantum gate implementation may realize a gate error reduction of 2, 4, 8-fold or greater. The described error-divisible quantum gates work to reduce random qubit error by decreasing the duration of a gate (provided there are no or minimal rate limiting steps (e.g., gate protocols that require qubit energies to be tuned in and out of resonance at the beginning and end of the gate)). The methods and principles described herein to achieve proportionally lower error for smaller angles (or other principles and methods) may be implemented in any multi-qubit quantum computer architecture (of any type of qubit) having small-angle one- and two-qubit gates. In some examples, the methods described herein may be implemented in a two-dimensional qubit structure. In other examples, the methods described herein may be implemented in a three-dimensional (3D) cavity structure, including implementing error-division quantum gates between two modes of the 3D cavity structure.

Error divisible quantum gates may enable a form of application-specific quantum error correction. For example, a vast array of quantum algorithms (including VQE and QAOA) amount to finding the ground state of some simulated Hamiltonian, using some combination of parametrized quantum circuits and simulated adiabatic evolution. Random error tends to raise the effective energy of the evolving quantum state, but in analog quantum simulation platforms, the increased effective energy may be counteracted via weak coupling to intentionally lossy objects that continuously lower the energy of the system, which may act as an effective error correction mechanism.

To minimize errors induced by the error correction mechanism itself, the coupling terms between the primary system and the lossy objects must be weak compared to the energy scales of the primary system itself. When implemented in digital platforms using small-angle two-qubit gates to auxiliary qubits which are frequently reset, the error for such gates may be the same as that of a full entangling gate. However, if error-divisible gates are used to implement the weak couplings, then the contribution of these gates to the total error rate may be proportionally much smaller and could be well below the rate at which the lossy elements correct errors.

An example method for implementing the error-divisible quantum gates includes use of a tunable coupler circuit with fixed energy qubits, and providing parametric gates by driving the tunable coupler circuit at the appropriate (high) frequencies. That is, to make the gates error divisible, one needs a set of waveforms where, if the time for a full entangling gate is t_{f} (e.g. CZ, or CPHASE(θ_{f}=π)), then to do a partial rotation θ=θ_{f}/k, the gate time may decrease as 1/k as well. In an example, error divisibility may be maintained down to ⅛th of a gate for iSWAP and ¼th of a gate for XCX.

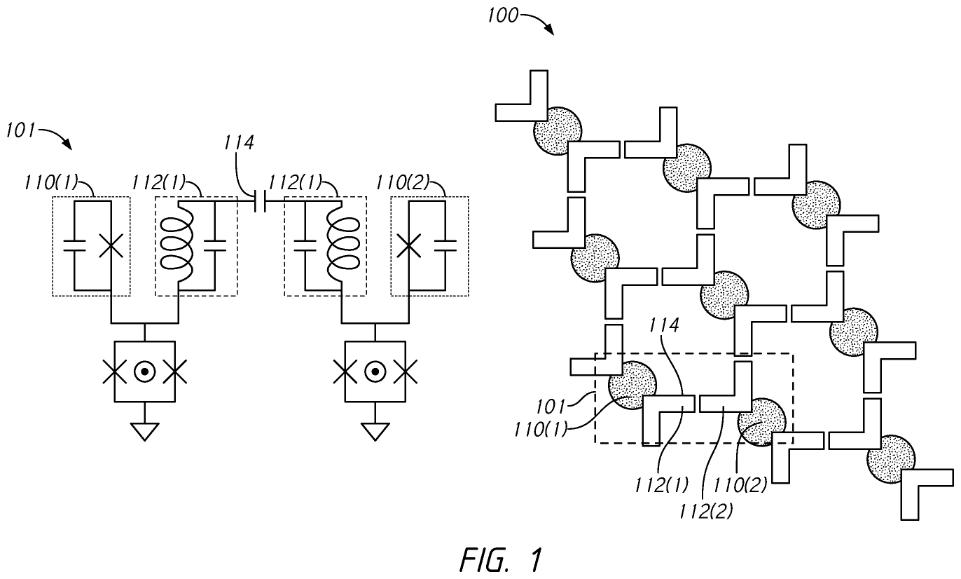

FIG. 1 is a schematic diagram of an example two-dimensional (2D) quantum system 100 in accordance with embodiments of the present disclosure. The system 100 includes a 2D grid of nearest neighbor qubits (e.g., blue circles), with each qubit is coupled to four resonators (e.g., each red L-shaped object represents a pair of resonators, such as resonators 112(1)-(2)), and each resonator is capacitively-coupled at 114 to a resonator for an adjacent qubit.

A schematic diagram 101 of the pair of transmon qubits 110(1)-(2) is shown on the left. Each of the transmon qubits 110(1)-(2) is coupled to a respective resonator 112(1)-(2), with the resonators 112(1)-(2) capacitively coupled to each other, as shown by capacitor 114. The system 100 shown in FIG. 1 is exemplary, and other implementations may be realized without departing from the scope of the disclosure. In addition, the implementation may be expanded to 3D cavity quantum systems without departing from the scope of the disclosure.

To set up the method for implementing error-divisible quantum gates, consider a family of two-qubit gates that can be parametrized by a total rotation angle θ, where θ=0 means no gate was applied and θ=θ_{f} is a full entangling operation. For example, CPHASE(θ) becomes a full CZ when θ=π, and does nothing for θ=0. If the average gate error for the full gate is E, an error-divisible gate may be defined as one in which the error for a partial rotation by angle θ=θ_{f}/k scales at least approximately as E/k. To determine a maximum k value, the method may include:

(1) Select an intrinsic gate error rate threshold (e.g., before considering random qubit error). An example acceptable intrinsic gate error rate may include 10⁻⁴. The intrinsic gate error rate may include leakage and any other unwanted processes generated by the gate itself.

(2) Find the robust minimum time t_{f} to reliably execute a full entangling gate at the selected intrinsic gate error rate (e.g., without excessive fine tuning). The minimum time t_{f} should robust enough to allow for small errors produced by small variations in the waveform (e.g., respecting filtering challenges, resolution limits, and other realistic experimental issues).

(3) For a rotation by θ_{f}=k, define an initial new gate time t_{g}=t_{f}/k. Test the new gate time and adjust, as necessary, to ensure that error remains below the selected intrinsic gate error rate threshold. Continue incrementing k for smaller rotations until the gate time is so short that the selected intrinsic gate error rate threshold cannot be satisfied. The value of k at this point is as far as error divisibility can be extended. Smaller rotations than this may be achieved by lowering amplitudes for this minimum t_{f}. To achieve an error-divisible gate, is may be helpful to use a waveform that instantaneously cancels unwanted terms (e.g., dispersive shifts and leakage) at some or all points during the gate. If the unwanted terms are mostly canceled, then it may be straightforward to apply the same type of waveform for progressively shorter durations to achieve smaller rotations.

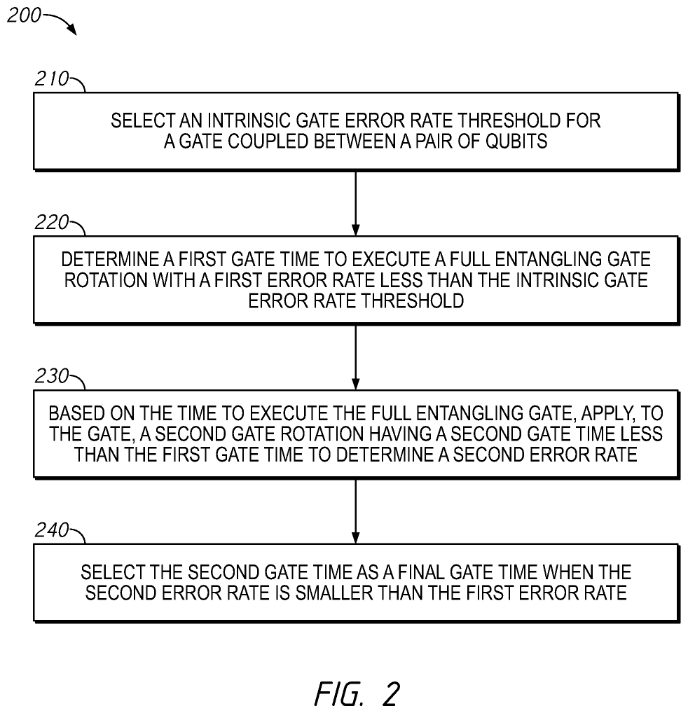

FIG. 2 is a flow diagram of a method for achieving an error divisible gate in a quantum system in accordance with embodiments of the present disclosure. The method 200 may be performed by or on the system 100 of FIG. 1.

The method 200 may include selecting an intrinsic gate error rate threshold for a gate coupled between a pair of transmon qubits, at 210. The method 200 may include determining a first gate time to execute a full entangling gate rotation with a first error rate less than the intrinsic gate error rate threshold, at 220. In some examples, the pair of qubits includes a primary bit coupled to an auxiliary qubit. In some examples, the pair of qubits are included in a multi-qubit architecture having a plurality of small angle one-bit and/or two-bit gates, including the gate.

The method 200 may include based on the time to execute the full entangling gate, applying, to the gate, a second gate rotation having a second gate time less than the first gate time to determine a second error rate, at 230. In some examples, the method 200 may further include determining the second error rate after application of the second gate rotation having the second time.

The method 200 may include selecting the second gate time as a final gate time when the second error rate is smaller than the first error rate, at 240. In some examples, the method 200 may further include based on the time to execute the full entangling gate, applying, to the gate, a third gate rotation having a third gate time less than the second gate time to determine a third error rate, and selecting the third gate rotation when the third error rate is smaller than the first error rate.

In some examples, the method 200 may further include iteratively applying, to the gate, incrementally smaller gate rotations having incrementally smaller gate times until an achieved error rate exceeds the first error rate. In some examples, the method 200 may further include applying, to the gate, a waveform having a frequency determined based on the second gate rotation to perform quantum error correction. In some examples, the method 200 may be performed with minimal rate limiting steps. In some examples, the method 200 may be performed with no rate limiting steps.

In some examples, the method 200 may include tuning the gate via a tunable coupling element. In some examples, the tunable coupling element may include a capacitor, an inductor, or a combination thereof. In some examples, the method 200 may further include tuning the pair of qubits, where the gate is configured to provide fixed coupling.

In some examples, the method 200 may further include operating, via a computing device, the plurality of small angle one-bit and/or two-bit gates based on a quantum algorithm and according to a schedule. In some examples, the method 200 may further include providing, via a compiler of the computing device, the schedule of operation of the plurality of small angle one-bit and/or two-bit gates to minimize a total runtime of the quantum algorithm.

For example, for implementation of the methods described herein on a multi-qubit quantum computer architecture having multiple error-divisible quantum gates, a computing device configured to execute instructions (e.g., stored at a memory of the computing device) via one or more processor units to control operation of the error-divisible quantum gates according to a schedule. For example, the computing device may be configured to parallelizes and/or synchronize the error divisible gates applied to multiple qubits such that a total runtime of the quantum algorithm is reduced or minimized. In addition, the computing device may be programmed with a compiler configured to (automatically) translate higher level or more complex instructions into sequences of error divisible gates to determine a schedule,

Appendix A includes specific, non-limiting examples of methods for implementing the error-divisible quantum gates. The contents of Appendix A are incorporated herein in their entirety for all purposes.

From the foregoing it will be appreciated that, although specific embodiments of the disclosure have been described herein for purposes of illustration, various modifications may be made without deviating from the spirit and scope of the disclosure. Accordingly, the disclosure is not limited except as by the appended claims.

1. A method for achieving an error divisible gate in a quantum system, comprising:
selecting an intrinsic gate error rate threshold for a gate coupled between a pair of qubits;
determining a first gate time to execute a full entangling gate rotation with a first error rate less than the intrinsic gate error rate threshold;
based on the time to execute the full entangling gate, applying, to the gate, a second gate rotation having a second gate time less than the first gate time to determine a second error rate; and
selecting the second gate time as a final gate time when the second error rate is smaller than the first error rate.

2. The method of claim 1, further comprising:
based on the time to execute the full entangling gate, applying, to the gate, a third gate rotation having a third gate time less than the second gate time to determine a third error rate; and
selecting the third gate rotation when the third error rate is smaller than the first error rate.

3. The method of claim 1, further comprising determining the second error rate after application of the second gate rotation having the second time.

4. The method of claim 1, further comprising iteratively applying, to the gate, incrementally smaller gate rotations having incrementally smaller gate times until an achieved error rate exceeds the first error rate.

5. The method of claim 1, further comprising applying, to the gate, a waveform having a frequency determined based on the second gate rotation to perform quantum error correction.

6. The method of claim 6, wherein the pair of qubits includes a primary bit coupled to an auxiliary qubit.

7. The method of claim 1, further comprising tuning the gate via a tunable coupling element.

8. The method of claim 1, wherein the tunable coupling element includes a capacitor, an inductor, or a combination thereof.

9. The method of claim 1, further comprising tuning the pair of qubits, wherein the gate is configured to provide fixed coupling.

10. The method of claim 1, wherein the pair of qubits are included in a multi-qubit architecture having a plurality of small angle one-bit and/or two-bit gates, including the gate.

11. The method of claim 10, further comprising operating, via a computing device, the plurality of small angle one-bit and/or two-bit gates based on a quantum algorithm and according to a schedule.

12. The method of claim 11, further comprising providing, via a compiler of the computing device, the schedule of operation of the plurality of small angle one-bit and/or two-bit gates to minimize a total runtime of the quantum algorithm.

13. The method of claim 1, further comprising tuning the pair of qubits in a multi-bit architecture such that small angle gates have a proportionally smaller error.

14. At least one computer-readable medium storing instructions that, when executed, cause a processor unit to:
select an intrinsic gate error rate threshold for a gate coupled between a pair of qubits;
determine a first gate time to execute a full entangling gate rotation with a first error rate less than the intrinsic gate error rate threshold;
based on the time to execute the full entangling gate, apply, to the gate, a second gate rotation having a second gate time less than the first gate time to determine a second error rate; and
select the second gate time as a final gate time when the second error rate is smaller than the first error rate.

15. The at least one computer-readable medium of claim 15, wherein instructions further cause the processor unit to:
based on the time to execute the full entangling gate, apply, to the gate, a third gate rotation having a third gate time less than the second gate time to determine a third error rate; and
select the third gate rotation when the third error rate is smaller than the first error rate.

16. The at least one computer-readable medium of claim 15, wherein instructions further cause the processor unit to determine the second error rate after application of the second gate rotation having the second time.

17. The at least one computer-readable medium of claim 15, wherein instructions further cause the processor unit to iteratively apply, to the gate, incrementally smaller gate rotations having incrementally smaller gate times until an achieved error rate exceeds the first error rate.

18. The at least one computer-readable medium of claim 15, wherein instructions further cause the processor unit to apply, to the gate, a waveform having a frequency determined based on the second gate rotation to perform quantum error correction.

19. The at least one computer-readable medium of claim 18, wherein the pair of qubits includes a primary bit coupled to an auxiliary qubit.

20. The at least one computer-readable medium of claim 15, wherein instructions further cause the processor unit to tune the gate via a tunable coupling element.

21. The at least one computer-readable medium of claim 15, wherein the tunable coupling element includes a capacitor, an inductor, or a combination thereof.

22. The at least one computer-readable medium of claim 15, wherein instructions further cause the processor unit to tune the pair of qubits, wherein the gate is configured to provide fixed coupling.

23. The at least one computer-readable medium of claim 15, wherein the pair of qubits are included in a multi-qubit architecture having a plurality of small angle one-bit and/or two-bit gates, including the gate.

24. The at least one computer-readable medium of claim 23, wherein instructions further cause the processor unit to operate the plurality of small angle one-bit and/or two-bit gates based on a quantum algorithm and according to a schedule.

25. The at least one computer-readable medium of claim 24, wherein instructions further cause the processor unit to provide, via a compiler, the schedule of operation of the plurality of small angle one-bit and/or two-bit gates to minimize a total runtime of the quantum algorithm.

26. The at least one computer-readable medium of claim 15, wherein instructions further cause the processor unit to tune the pair of qubits in a multi-bit architecture such that small angle gates have a proportionally smaller error.
